(19) United States
(12) Patent Application Publication
(10) Pub. No.: US 2017/0259271 A1
(43) Pub. Date: Sep. 14, 2017

(54) TOOTH AND TOOTHHOLDER FOR INDUSTRIAL MULCHING APPARATUS

(71) Applicant: IMEX Sourcing Inc., Edmonton (CA)

(72) Inventor: Marcel Noël, Edmonton (CA)

(21) Appl. No.: 15/452,868

(22) Filed: Mar. 8, 2017

Related U.S. Application Data
(60) Provisional application No. 62/305,120, filed on Mar. 8, 2016.

(51) Int. Cl. B02C 18/18; E02F 9/28; A01B 33/10; A01G 3/00

(52) U.S. Cl. CPC B02C 18/18; A01G 3/002; E02F 9/2866; A01B 33/103

(57) ABSTRACT

A tooth and a toothholder for a mulching apparatus. The tooth includes a body, a cutting element mounted to the body, and a mounting element projecting from the body. The toothholder includes a mounting recess for receiving the mounting element. The mounting element engages the mounting recess to prevent rotation of the tooth relative to the toothholder. The mounting element may be shaped to engage with the toothholder to prevent rotation of the tooth relative to the toothholder. The mounting element may include a plurality of outer engagement surfaces. The plurality of outer engagement surfaces may define an exterior profile of the mounting element that is polygonal in shape.

### CROSS-REFERENCE TO RELATED APPLICATION

This application claims priority to U.S. Provisional Application No. 62/305,120 filed on Mar. 8, 2016, the entire contents of which are hereby incorporated herein by reference.

### FIELD

The present disclosure relates generally to mulching teeth and toothholders for industrial mulching apparatuses.

### BACKGROUND

The following paragraphs are not an admission that anything discussed in them is prior art or part of the knowledge of persons skilled in the art.

U.S. Pat. No. 6,520,440 describes a comminuting striker assembly for mounting on a rotor of a comminuting apparatus including: a striker having first and second opposed faces, the first face defining at least one cutting edge, and the second face defining a pair of perpendicular slots; a striker retainer having a leading face for attachment to the striker, the leading face defining a pair of perpendicular keys to be received by the slots; and a single threaded fastener for joining the striker to the striker retainer.

U.S. Pat. No. 7,380,576 B2 describes a milling tooth body for a comminution machine has a working side, oriented in a working direction; a flange side detachably connected to a milling tooth holder of the comminution machine; a tooth tip on the side of a recess; and a base at an end of the tooth body facing away from the tooth tip. A cutter device is in the recess. The flange side on the tooth body is opposite the working side. An entire side of the tooth body, which is oriented in the working direction, is the working side. The tooth tip projects away from the flange side in the direction of a longitudinal axis of the tooth body, perpendicular to the working direction. A first section of the tooth body projects away from the flange side in a direction parallel to and opposite the working direction.

U.S. Pat. No. 7,578,462 describes a mulcher apparatus that includes a tractor and a mulcher unit provided to the tractor. The mulcher unit includes a tooth assembly with a holder and a cutter element with a cooperating notch portion and cross bar arrangement. The notch portion can be retrofit to existing holder arrangements. The cutter element may include various features, to enhance cutting efficiency. For example, the cutter elements may include a double-ended structure, angle tab portions at each corner portion, carbide coatings, a pair of tip portions at each end with a space therebetween, and/or a generally H-shaped configuration.

Canadian Patent Application No. 2,863,311 A1 describes a tool, a toolholder and a toolholder unit obtained by coupling the tool and toolholder and adapted to be fixed to a rotor of a shredder. The tool and the toolholder include coupling means that permit a quick and easy assembly or disassembly of the two elements and ensure, at the same time, a stable and safe fixing during the use of the tool itself.

### INTRODUCTION

The following is intended to introduce the reader to the detailed description that follows and not to define or limit the claimed subject matter.

In an aspect, the present disclosure relates to a tooth for use in combination with a toothholder of a mulching apparatus. The tooth may include: a body; a cutting element mounted to the body; and a mounting element projecting from the body, wherein the mounting element is adapted to engage the toothholder to prevent rotation of the tooth relative to the toothholder.

The mounting element may be shaped to engage with the toothholder to prevent rotation of the tooth relative to the toothholder. The mounting element may include a plurality of outer engagement surfaces. The plurality of outer engagement surfaces may define an exterior profile of the mounting element that is polygonal in shape. The mounting element may have four of the outer engagement surfaces so that the exterior profile is cuboidal in shape. The mounting element may have eight of the outer engagement surfaces so that the exterior profile is octagonal in shape. Other shapes and configurations are possible.

The tooth may include a bore for receiving a fastener to connect the tooth and the toothholder. The bore may extend through the body and define a bore axis. The mounting element may be shaped to engage with the toothholder to prevent rotation of the tooth relative to the toothholder about the bore axis. The tooth may include a front recess for receiving a portion of the fastener when assembled. The bore may extend between the front recess and the mounting element through the body. The tooth may include a front face arranged between the front recess and the cutting element. The front face and the front recess may be arranged so that the portion of the fastener is offset rearwardly relative the front face to define an offset dimension.

The tooth may include first, second and third abutment surfaces. The first abutment surface may be disposed on a plane above the mounting element. The mounting element may project rearwardly from the second abutment surface. The third abutment surface may be disposed on a plane below the mounting element.

In an aspect, the present disclosure relates to a combination of: a tooth including a body, a cutting element mounted to the body, and a mounting element projecting from the body; and a toothholder including a mounting recess for receiving the mounting element, wherein the mounting element is adapted to engage the mounting recess to prevent rotation of the tooth relative to the toothholder.

The mounting element and the mounting recess may be complementary in shape. The mounting element may include a plurality of outer engagement surfaces. The mounting recess may include a plurality of inner sidewalls. Engagement between the outer engagement surfaces and the inner sidewalls may prevent rotation of the tooth relative to the toothholder. The plurality of outer engagement surfaces may define an exterior profile of the mounting element that is polygonal in shape. The mounting element may have four of the outer engagement surfaces so that the exterior profile is cuboidal in shape. The mounting element may have eight of the outer engagement surfaces so that the exterior profile is octagonal in shape.

The combination may include a fastener connecting the tooth and the toothholder. The tooth may include a bore for receiving the fastener. The bore may extend through the body and define a bore axis. The mounting element may be shaped to engage with the mounting recess to prevent rotation of the tooth relative to the toothholder about the bore axis. The tooth may include a front recess for receiving a portion of the fastener when assembled. The bore may extend between the front recess and the mounting element through the body. The tooth may include a front face arranged between the front recess and the cutting element. The front face and the front recess may be arranged so that the portion of the fastener is offset rearwardly relative the front face to define an offset dimension.

The tooth may include first, second and third abutment surfaces. The toothholder may include first, second and third support surfaces. The abutment surfaces may be arranged to engage the support surfaces when the tooth is assembled with the toothholder. The first abutment surface may be disposed on a plane above the mounting element. The mounting element may project rearwardly from the second abutment surface. The third abutment surface may be disposed on a plane below the mounting element.

In an aspect, the present disclosure relates to a tooth for use in combination with a toothholder of a mulching apparatus. The tooth may include: a body; a cutting element mounted to the body; and a plurality of outer engagement surfaces projecting from the body, wherein the plurality of outer engagement surfaces define an exterior profile that is polygonal in shape for engaging the toothholder to prevent rotation of the tooth relative to the toothholder.

Other aspects and features of the teachings disclosed herein will become apparent, to those ordinarily skilled in the art, upon review of the following description of the specific examples of the present disclosure.

### BRIEF DESCRIPTION OF THE DRAWINGS

The drawings included herewith are for illustrating various examples of apparatuses and methods of the present disclosure and are not intended to limit the scope of what is taught in any way. In the drawings:

FIG. 1 is a front, top, right side perspective view of a tooth in accordance with a first example;

FIG. 2 is a top view of the tooth of FIG. 1;

FIG. 3 is a rear, top, right side perspective view of the tooth of FIG. 1;

FIG. 4 is a front view of the tooth of FIG. 1;

FIG. 5 is a right side view of the tooth of FIG. 1;

FIG. 6 is a rear view of the tooth of FIG. 1;

FIG. 7 is a front, bottom, right side perspective view of the tooth of FIG. 1;

FIG. 8 is a bottom view of the tooth of FIG. 1;

FIG. 9 is a rear, bottom, right side perspective view of the tooth of FIG. 1;

FIG. 10 is an exploded perspective view of the tooth of FIG. 1 in combination with a toolholder and a fastener;

FIG. 11 is a perspective view of the tooth of FIG. 1 assembled in combination with the toolholder and the fastener;

FIG. 12 is a front view of the tooth of FIG. 1 assembled in combination with the toolholder and the fastener;

FIG. 13 is sectional view along line 13-13 in FIG. 12;

FIG. 14 is a front, top, right side perspective view of a tooth in accordance with a second example;

FIG. 15 is a top view of the tooth of FIG. 14;

FIG. 16 is a rear, top, right side perspective view of the tooth of FIG. 14;

FIG. 17 is a front view of the tooth of FIG. 14;

FIG. 18 is a right side view of the tooth of FIG. 14;

FIG. 19 is a rear view of the tooth of FIG. 14;

FIG. 20 is a front, bottom, right side perspective view of the tooth of FIG. 14;

FIG. 21 is a bottom view of the tooth of FIG. 14; and

FIG. 22 is a rear, bottom, right side perspective view of the tooth of FIG. 14.

### DETAILED DESCRIPTION

Various apparatuses or methods will be described below to provide an example of an embodiment of each claimed invention. No embodiment described below limits any claimed invention and any claimed invention may cover apparatuses and methods that differ from those described below. The claimed inventions are not limited to apparatuses and methods having all of the features of any one apparatus or method described below, or to features common to multiple or all of the apparatuses or methods described below. It is possible that an apparatus or method described below is not an embodiment of any claimed invention. Any invention disclosed in an apparatus or method described below that is not claimed in this document may be the subject matter of another protective instrument, for example, a continuing patent application, and the applicant(s), inventor(s) and/or owner(s) do not intend to abandon, disclaim or dedicate to the public any such invention by its disclosure in this document.

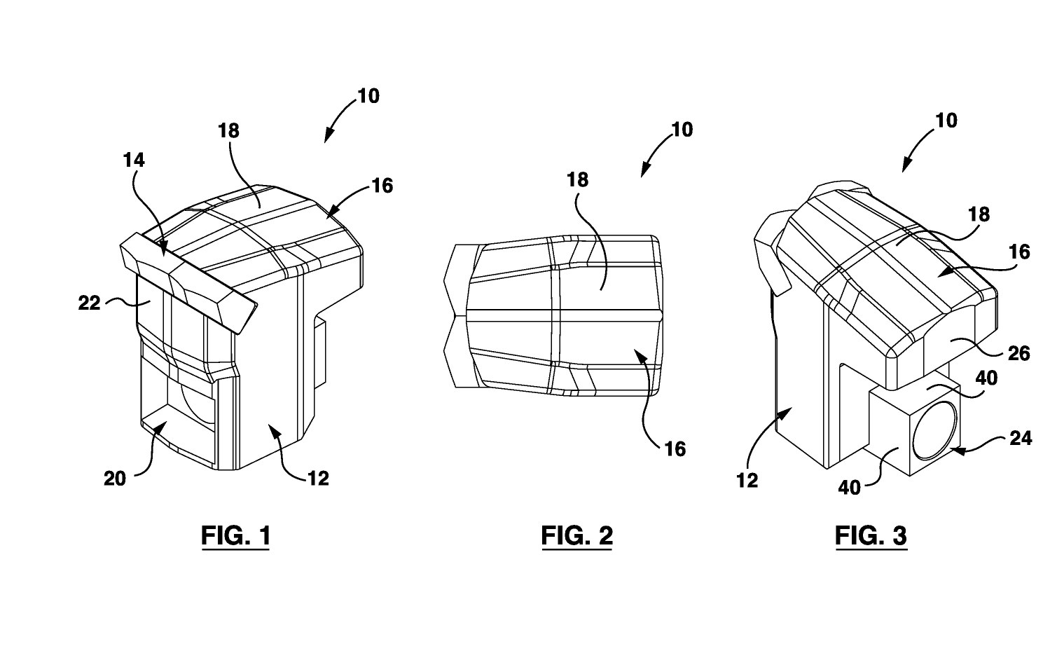

Referring to FIGS. 1, 2 and 3, a first example of a mulching tooth is shown generally at reference numeral 10. The tooth 10 includes a body 12, and a cutting element 14 mounted to the body 12. The body 12 may be formed of a tough material, e.g., a stainless steel, and the cutting element 14 may be formed of a hard material, e.g., a tungsten carbide.

In the example illustrated, referring to FIGS. 1 and 2, the body 12 includes a protruding portion 16 that projects rearwardly relative to the cutting element 14. An upper face 18 is arranged between the cutting element 14 and the protruding portion 16.

In the example illustrated, referring to FIG. 1, the body 12 includes a front recess 20, and a front face 22 is arranged between the front recess 20 and the cutting element 14.

In the example illustrated, referring to FIG. 3, the tooth 10 includes a mounting element 24 that extends rearwardly relative to the body 12, and the protruding portion 16 defines a rear face 26 above the mounting element 24.

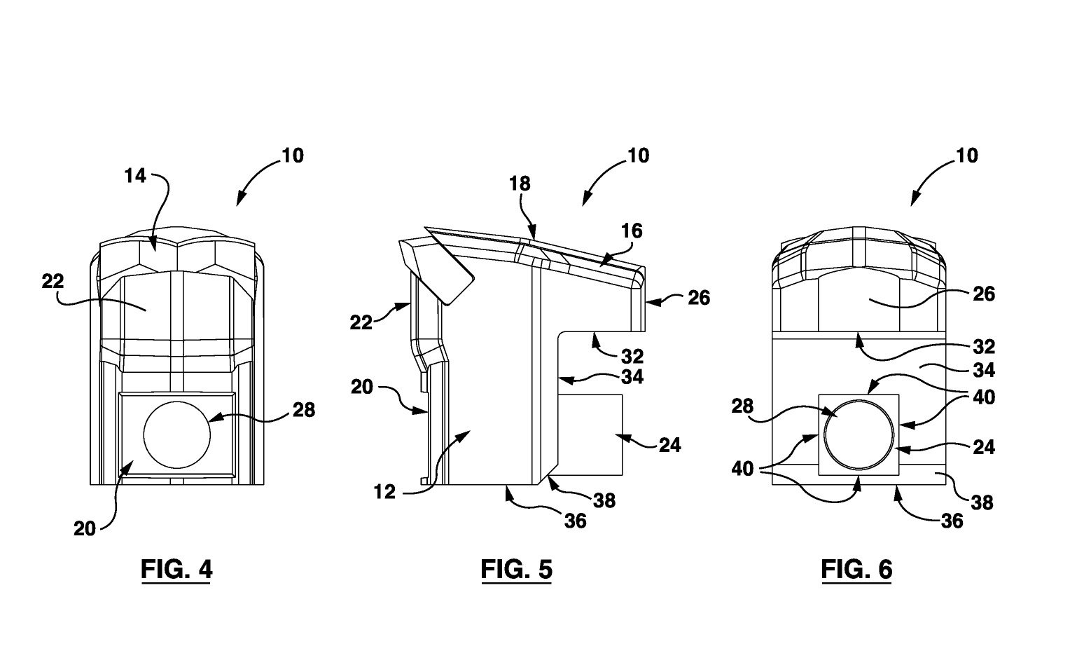

Referring to FIGS. 4, 5 and 6, the front recess 20 and the mounting element 24 are aligned in registration, and a bore 28 extends therebetween through the body 12. The bore 28 receives a fastener, as described below.

In the example illustrated, referring to FIGS. 5 and 6, the body 12 includes an abutment surface 32 on a lower surface thereof, an abutment surface 34 on a rear surface thereof, and an abutment surface 36 on a lower surface thereof. The abutment surfaces 32, 36 are shown to be parallel to one another, and each is shown to be orthogonal to the abutment surface 34, outlining a zigzag pattern. A bevel edge 38 is shown separating the abutment surfaces 34, 36.

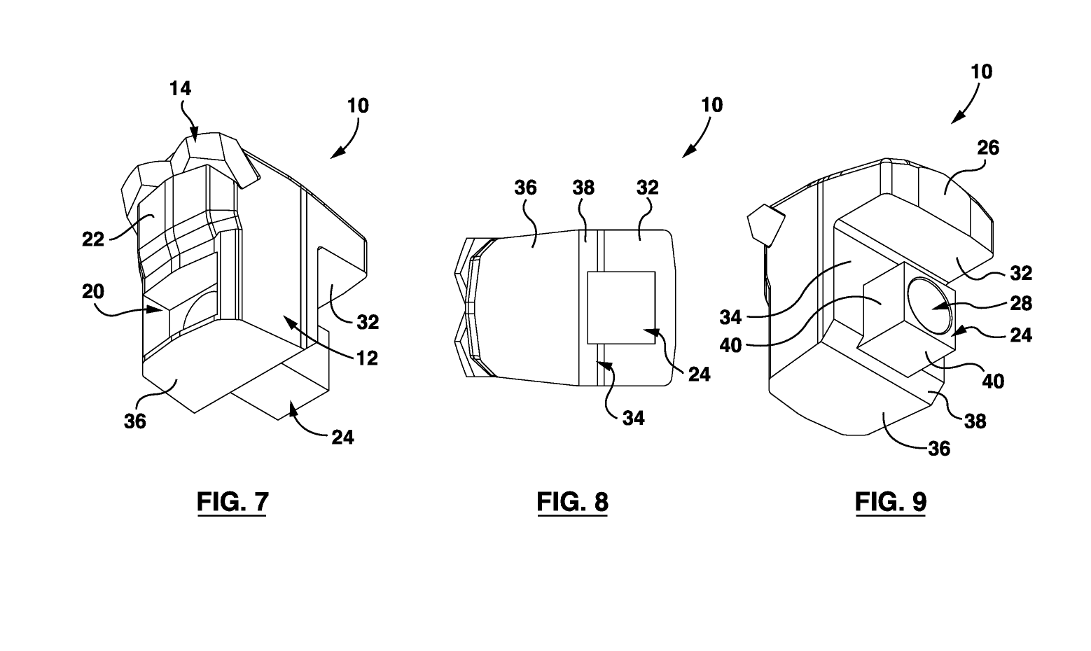

Referring to FIGS. 7, 8 and 9, the mounting element 24 projects rearwardly from the abutment surface 34, and the abutment surfaces 32, 36 are each spaced apart from the mounting element 24. In the example illustrated, the abutment surface 32 is disposed on a plane that is offset above the mounting element 24, and the abutment surface 36 is disposed on a plane that is offset below the mounting element 24.

Referring particularly to FIGS. 3, 6 and 9, the mounting element 24 is shown to include a plurality of outer engagement surfaces 40 spaced about an outer periphery thereof. In the example illustrated, the mounting element 24 has four of the engagement surfaces 40, defining an exterior profile that is square or cuboidal in shape.

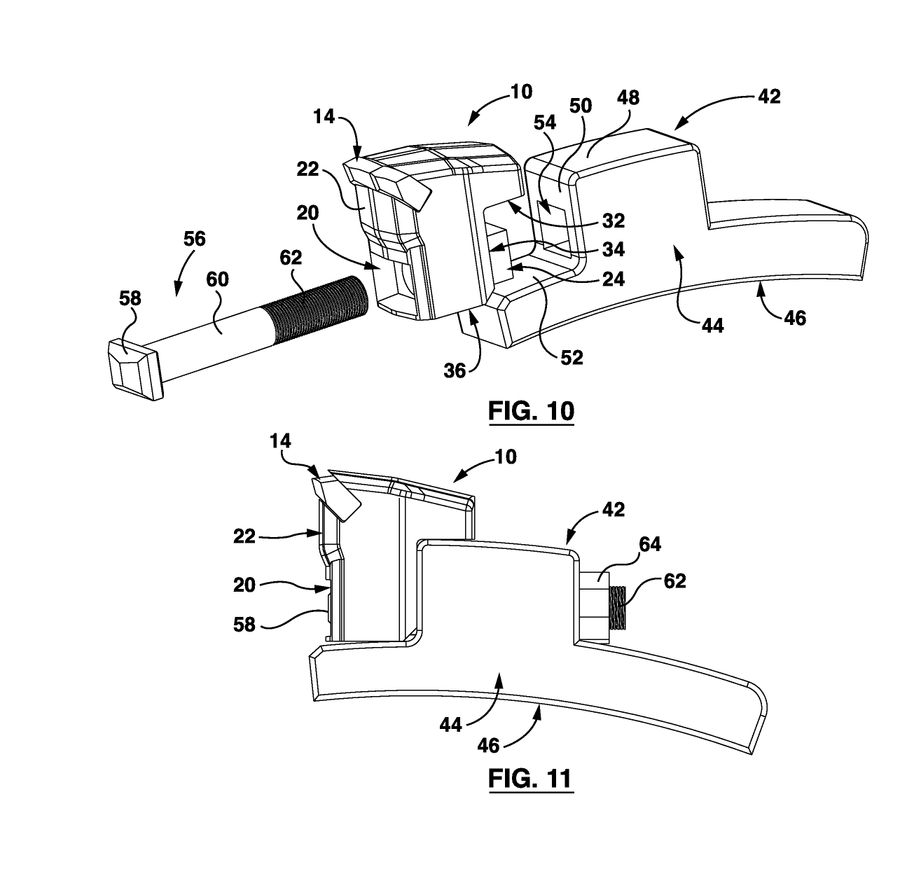

Referring to FIGS. 10 and 11, the tooth 10 is adapted for assembly in combination with a toothholder 42. The toothholder 42 includes a body 44. The body 44 is shown to have a curved lower surface 46 that may be used to fix the toothholder 42 to a rotor of an industrial mulcher, a milling cutter, a shredder and/or other crushing/mincing machine.

In the example illustrated, the toothholder 42 includes support surfaces 48, 50, 52. The abutment surfaces 32, 34, 36 of the tooth 10 are arranged to engage the support surfaces 48, 50, 52, respectively, of the toothholder 42 when the tooth 10 is assembled with the toothholder 42.

In the example illustrated, the toothholder 42 includes a mounting recess 54 that receives the mounting element 24 of the tooth 10 when the tooth 10 is assembled with the toothholder 42. The mounting recess 54 is shown to have four inner sidewalls, defining an interior profile that is square or cuboidal in shape.

In the example illustrated, a fastener 56 connects the tooth 10 and the toothholder 42. The fastener 56 is shown to include a bolt head 58, a bolt body 60 and threaded portion 62. A nut 64 is threaded to the threaded portion 62 to secure the tooth 10 and the toothholder 42 together.

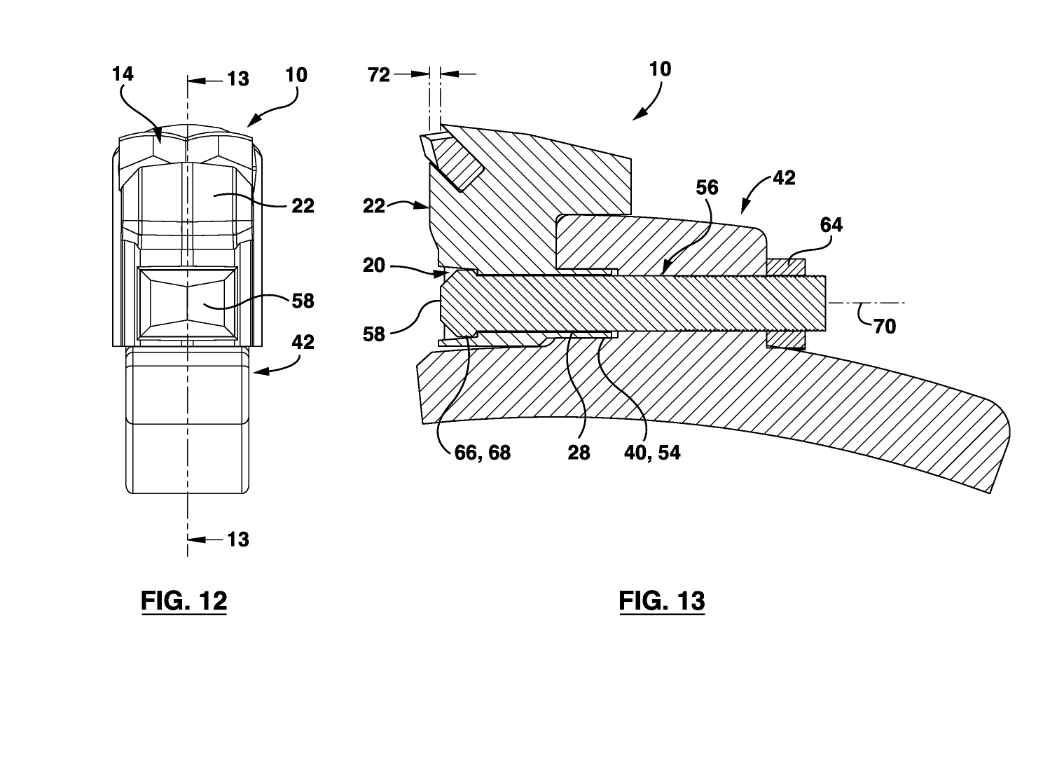

Referring to FIGS. 12 and 13, the front recess 20 receives the bolt head 58. An outer profile of the bolt head 58 may be shaped to correspond with an inner profile of the front recess 20. In the example illustrated, the bolt head 58 and the front recess 20 are generally rectangular in shape, and engagement between outer edges 66 of the bolt head 58 and inner sidewalls 68 of the front recess 20 prevent rotation of the fastener 56 about a bore axis 70.

In the example illustrated, when the tooth 10 and the toothholder 42 are secured together, the bolt head 58 is offset rearwardly relative the front face 22 to define an offset dimension 72. This arrangement may protect the bolt head 58 from wear during use.

Referring particularly to FIGS. 6, 10 and 13, the mounting recess 54 and the mounting element 24 are complementary in shape. The mounting recess 54 receives the mounting element 24, and engagement between the engagement surfaces 40 of the mounting element 24 and the inner sidewalls of the mounting recess 54 prevents rotation of the tooth 10 relative to the toothholder 42. In the example illustrated, engagement between the engagement surfaces 40 of the mounting element 24 and the mounting recess 54 prevent rotation of the tooth 10 relative to the toothholder 42 about the bore axis 70. This interlocking arrangement improves the connection between the tooth 10 and the toothholder 42 when assembled and may lessen load that is applied to the fastener 56 when in use.

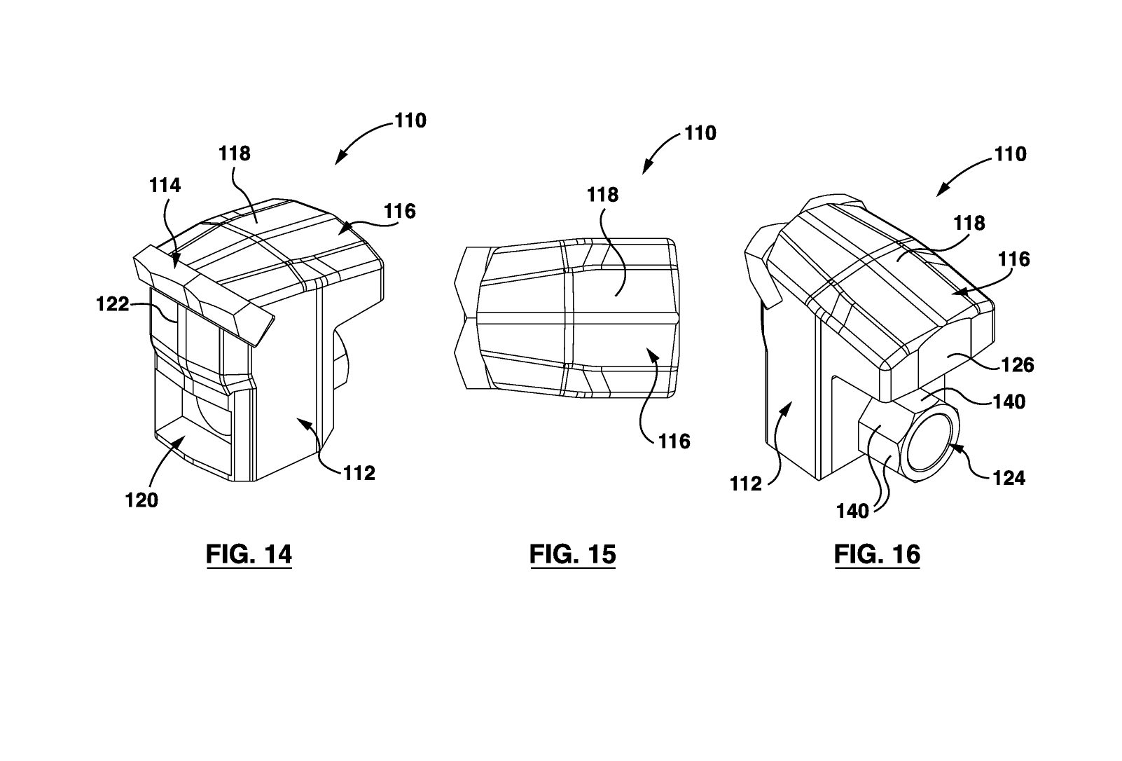

Referring to FIGS. 14, 15 and 16, a second example of a mulching tooth is shown generally at reference numeral 110. The tooth 110 includes a body 112, and a cutting element 114 mounted to the body 112. The body 112 may be formed of a tough material, e.g., a stainless steel, and the cutting element 114 may be formed of a hard material, e.g., a tungsten carbide.

In the example illustrated, referring to FIGS. 14 and 15, the body 112 includes a protruding portion 116 that projects rearwardly relative to the cutting element 114. An upper face 118 is arranged between the cutting element 114 and the protruding portion 116.

In the example illustrated, referring to FIG. 14, the body 112 includes a front recess 120, and a front face 122 is arranged between the front recess 120 and the cutting element 114.

In the example illustrated, referring to FIG. 16, the tooth 110 includes a mounting element 124 that extends rearwardly relative to the body 112, and the protruding portion 116 defines a rear face 126 above the mounting element 124.

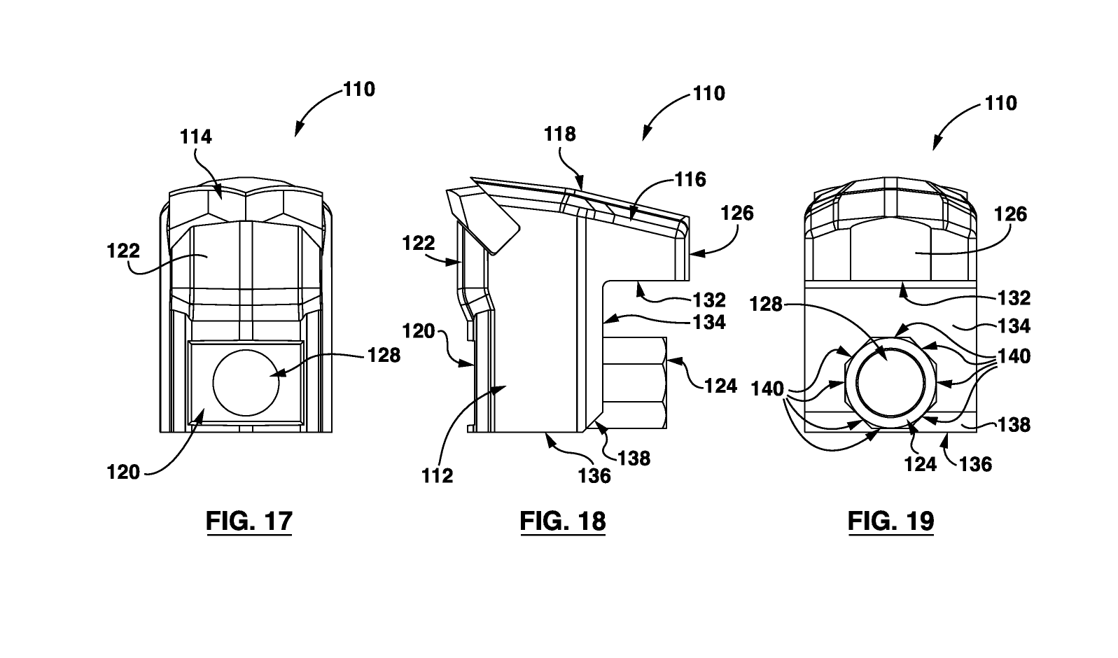

Referring to FIGS. 17, 18 and 19, the front recess 120 and the mounting element 124 are aligned in registration, and a bore 128 extends therebetween through the body 112. The bore 128 receives a fastener, as described below.

In the example illustrated, referring to FIGS. 18 and 19, the body 112 includes an abutment surface 132 on a lower surface thereof, an abutment surface 134 on a rear surface thereof, and an abutment surface 136 on a lower surface thereof. The abutment surfaces 132, 136 are shown to be parallel to one another, and each is shown to be orthogonal to the abutment surface 134, outlining a zigzag pattern. A bevel edge 138 is shown separating the abutment surfaces 134, 136.

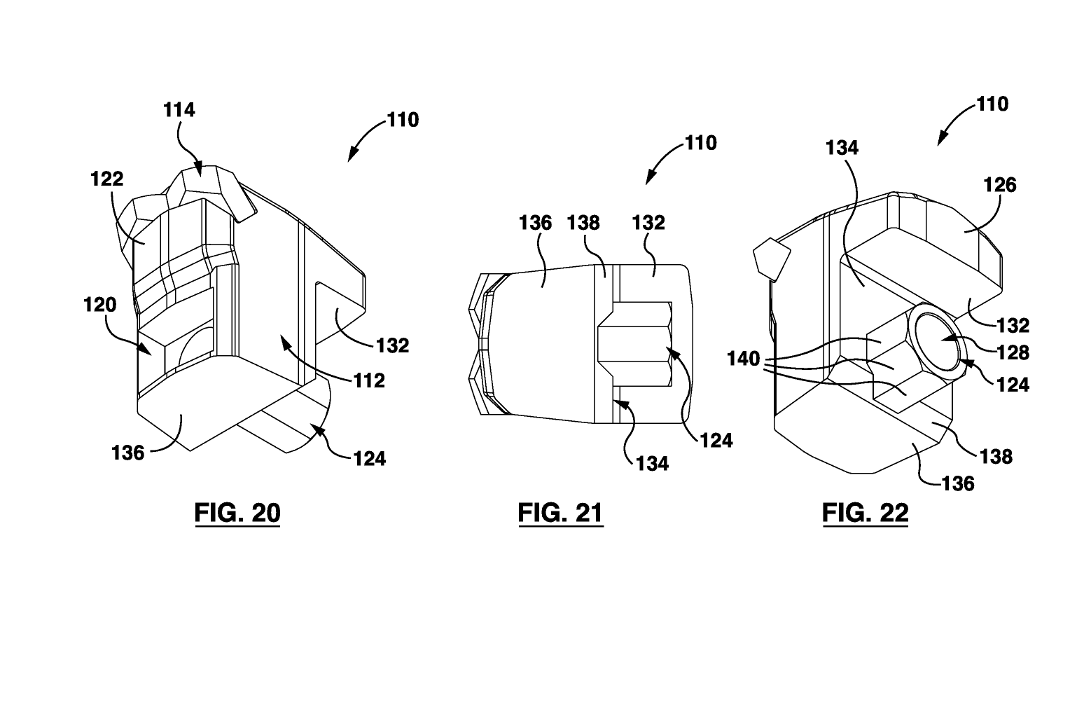

Referring to FIGS. 20, 21 and 22, the mounting element 124 projects rearwardly from the abutment surface 134, and the abutment surfaces 132, 136 are each spaced apart from the mounting element 124. In the example illustrated, the abutment surface 132 is disposed on a plane that is offset above the mounting element 124, and the abutment surface 136 is disposed on a plane that is offset below the mounting element 124.

Referring particularly to FIGS. 16, 19 and 22, the mounting element 124 is shown to include a plurality of outer engagement surfaces 140 spaced about an outer periphery thereof. In the example illustrated, the mounting element 124 has eight of the engagement surfaces 140, defining an exterior profile that is octagonal in shape.

The tooth 110 is adapted for assembly in combination with a toothholder (not shown), which may be similar to the toothholder 42 herein. The toothholder includes a mounting recess that receives the mounting element 124 of the tooth 110 when the tooth 110 is assembled with the toothholder. The mounting recess may have eight inner sidewalls, defining an interior profile that is octagonal in shape. Engagement between the engagement surfaces 140 of the mounting element 124 and the inner sidewalls of the mounting recess prevents rotation of the tooth 110 relative to the toothholder.

In the examples described and illustrated in the present disclosure, the mounting elements of the teeth each include a plurality of outer engagement surfaces spaced about an outer periphery thereof, defining an exterior profile that is polygonal in shape. Correspondingly, the mounting recess of the toothholder includes inner sidewalls that are complementary to that of the engagement surfaces, so that, once assembled, engagement between the engagement surfaces of the mounting element and the inner sidewalls of the mounting recess prevents rotation of the tooth relative to the toothholder. While cuboidal and octagonal examples are presented herein, it will be appreciated that other interlocking shapes of a mounting element and/or a recess are possible to prevent rotation of the tooth relative to the toothholder, including polygonal and non-polygonal shapes. Various configurations are possible.

While the above description provides examples of one or more apparatuses or methods, it will be appreciated that other apparatuses or methods may be within the scope of the accompanying claims.

I claim:

1. A tooth for use in combination with a toothholder of a mulching apparatus, comprising:
a body;
a cutting element mounted to the body; and
a mounting element projecting from the body,
wherein the mounting element is adapted to engage the toothholder to prevent rotation of the tooth relative to the toothholder.

2. The tooth of claim 1, wherein the mounting element is shaped to engage with the toothholder to prevent rotation of the tooth relative to the toothholder.

3. The tooth of claim 2, wherein the mounting element comprises a plurality of outer engagement surfaces.

4. The tooth of claim 3, wherein the plurality of outer engagement surfaces defines an exterior profile of the mounting element that is polygonal in shape.

5. The tooth of claim 4, wherein the mounting element has four of the outer engagement surfaces so that the exterior profile is cuboidal in shape.

6. The tooth of claim 4, wherein the mounting element has eight of the outer engagement surfaces so that the exterior profile is octagonal in shape.

7. The tooth of claim 1, comprising a bore for receiving a fastener to connect the tooth and the toothholder, the bore extending through the body and defining a bore axis, and the mounting element is shaped to engage with the toothholder to prevent rotation of the tooth relative to the toothholder about the bore axis.

8. The tooth of claim 7, comprising a front recess for receiving a portion of the fastener when assembled, the bore extending between the front recess and the mounting element through the body.

9. The tooth of claim 8, comprising a front face arranged between the front recess and the cutting element, and the front face and the front recess are arranged so that the portion of the fastener is offset rearwardly relative the front face to define an offset dimension.

10. The tooth of claim 1, comprising first, second and third abutment surfaces, wherein the first abutment surface is disposed on a plane above the mounting element, the mounting element projects rearwardly from the second abutment surface, and the third abutment surface is disposed on a plane below the mounting element.

11. In combination:
a tooth comprising a body, a cutting element mounted to the body, and a mounting element projecting from the body; and
a toothholder comprising a mounting recess for receiving the mounting element,
wherein the mounting element is adapted to engage the mounting recess to prevent rotation of the tooth relative to the toothholder.

12. The combination of claim 11, wherein the mounting element and the mounting recess are complementary in shape.

13. The combination of claim 12, wherein the mounting element comprises a plurality of outer engagement surfaces, the mounting recess comprises a plurality of inner sidewalls, and engagement between the outer engagement surfaces and the inner sidewalls prevents rotation of the tooth relative to the toothholder.

14. The combination of claim 13, wherein the plurality of outer engagement surfaces defines an exterior profile of the mounting element that is polygonal in shape.

15. The combination of claim 14, wherein the mounting element has four of the outer engagement surfaces so that the exterior profile is cuboidal in shape.

16. The combination of claim 14, wherein the mounting element has eight of the outer engagement surfaces so that the exterior profile is octagonal in shape.

17. The combination of claim 11, comprising a fastener connecting the tooth and the toothholder.

18. The combination of claim 17, wherein the tooth comprises a bore for receiving the fastener, the bore extending through the body and defining a bore axis, and the mounting element is shaped to engage with the mounting recess to prevent rotation of the tooth relative to the toothholder about the bore axis.

19. The combination of claim 18, wherein the tooth comprises a front recess for receiving a portion of the fastener when assembled, the bore extending between the front recess and the mounting element through the body.

20. The combination of claim 19, wherein the tooth comprises a front face arranged between the front recess and the cutting element, and the front face and the front recess are arranged so that the portion of the fastener is offset rearwardly relative the front face to define an offset dimension.

21. The combination of claim 11, wherein the tooth comprises first, second and third abutment surfaces, the toothholder comprises first, second and third support surfaces, and the abutment surfaces are arranged to engage the support surfaces when the tooth is assembled with the toothholder.

22. The combination of claim 21, wherein the first abutment surface is disposed on a plane above the mounting element, the mounting element projects rearwardly from the second abutment surface, and the third abutment surface is disposed on a plane below the mounting element.

23. A tooth for use in combination with a toothholder of a mulching apparatus, comprising:
a body;
a cutting element mounted to the body; and
a plurality of outer engagement surfaces projecting from the body,
wherein the plurality of outer engagement surfaces define an exterior profile that is polygonal in shape for engaging the toothholder to prevent rotation of the tooth relative to the toothholder.
